(19) United States
(12) Patent Application Publication
(10) Pub. No.: US 2018/0353366 A1
(43) Pub. Date: Dec. 13, 2018

(54) UPPER EXTREMITY REHABILITATION DEVICE

(71) Applicant: YEUNG KI KIM, Daegu (KR)

(72) Inventors: YEUNG KI KIM, Daegu (KR); KIBEOM KIM, Daegu (KR); KYEONGMIN KIM, Daegu (KR); SIWOO KIM, Daegu (KR)

(73) Assignee: YEUNG KI KIM, Daegu (KR)

(21) Appl. No.: 15/873,222

(22) Filed: Jan. 17, 2018

(30) Foreign Application Priority Data
Jun. 13, 2017 (KR) 10-2017-0073717

(51) Int. Cl. A61H 1/02; A63B 23/16

(52) U.S. Cl. CPC A61H 1/0288; A61H 2001/0203; A61H 2205/067; A63B 23/16

(57) ABSTRACT

Disclosed is an upper extremity rehabilitation device for unfolding fingers corresponding to an upper extremity of a human body. The upper extremity rehabilitation device includes a first support part located at a palm of a user; and a first rotation part configured to rotate the first support part so that one side of the first support part moves from at least one finger of a user to another finger to unfold fingers having different lengths.

### BACKGROUND

### (a) Technical Field

The present invention relates to an upper extremity rehabilitation device, and more particularly to an upper extremity rehabilitation device for unfolding fingers corresponding to an upper extremity of a human body.

### (b) Background Art

A finger rehabilitating apparatus including a hand support unit configured to support a hand of a patient and a finger motion unit configured to unfold fingers of a hand supported on the hand support unit is disclosed in Korean Unexamined Patent Publication No. 10-2012-0139473 (publication date: Dec. 27, 2012). The finger motion unit includes a finger locking part formed therein with a locking hole in which the finger is locked; a rotating rod part including a first point connected to the finger locking part; a support rod axially pin-engaged with the rotating rod part at a second point of the rotating rod part to support the rotating rod part; and a rotating rod driver engaged with the rotating rod part at a third point of the rotating rod part to rotating the rotting rod part based on an axis of the second point.

A finger rehabilitation apparatus capable of preventing a rehabilitation trainer from being injured due to a mechanical abnormal operation by disposing a magnetic force generator at a tip member of a robot finger, by performing rehabilitation training according to motion of the robot finger by applying a magnetic response member corresponding to an end of a finger of the rehabilitation trainer, and by removing magnetic force of the magnetic force generator or converting a polarity of the magnetic force when the magnetic force generator fails is disclosed in Korean Patent No. 10-16388499 (Issue date: Jul. 11, 2016). The finger rehabilitation apparatus includes a rehabilitation training robot hand including robot fingers corresponding to fingers of a person, respectively and provided therein with an end portion including a tip member having a magnetic force generator; a magnetic force response member inserted into the end portion of a finger of the rehabilitation trainer to make contact with the tip member of a rehabilitation training robot hand and responding to the magnetic force generator by attractive force or repulsive force; and a control unit configured to control a movement of the robot finger and an intensity and a polarity of a magnetic force generated from and the magnetic force generator.

A finger rehabilitating apparatus is disclosed in Korean Unexamined Patent Publication No. 10-2014-0095198 (publication date: Aug. 1, 2014). The finger rehabilitating apparatus includes a pair of first rotating links provided therein with an end hinged to a pair of brackets spaced apart from each other at a case; a finger positioning part installed at an end portion of the first rotating link so that fingers are positioned thereof; a sliding block movably installed in a straight line at the case; a second rotating link including an end hinged to a center portion of the first rotating link and another end hinged to the sliding block and to rotate the first rotating link according to a straight motion of the sliding block; and a driver configured to move the sliding block forward and rearward. Rehabilitating training with respect to fingers or wrists may be performed by force by repeatedly rotting paralyzed fingers or a finger positioning part on which wrists are positioned within a predetermined range.

### SUMMARY

The present invention provides an upper extremity rehabilitation device.

In accordance with an aspect of the present invention, there is provided an upper extremity rehabilitation device including: a first support part located at a palm of a user; and a first rotation part configured to rotate the first support part so that one side of the first support part moves from at least one finger of a user to another finger to unfold fingers having different lengths.

The first support part may include a wider middle part.

The first rotation part may include: a rotation body part in which the first support part is provided; a rotation moving part configured to advance and retreat the rotation body part from a wrist of the user in a heading direction of a palm; and a body rotating part configured to rotate the rotation body part.

The rotation moving part may include: a moving bar formed therein with a thread to be rotated; a moving body being bi-directionally moved in a rotation direction of a moving bar; and a moving rotation shaft configured in a heading direction of a palm of the user in the moving bar, wherein the rotation body part may include: a rotation body in which the first support part is configured; a body rotation shaft configured in the same direction as that of the moving rotation shaft in the rotation body; a body connector including both sides inserted into the moving rotation shaft and the body rotation shaft; and a body guide provided in the same direction as that of the body rotation shaft in the rotation body, wherein the body guide may be inserted into the body rotating part so that the body rotating part is moved with a curve based on the moving rotation shaft or the body rotation shaft.

The rotation body part may further include a body fixing guide configured in the same direction as that of the body guide, and the body rotating part may include a body fixing hole in which the body fixing guide is inserted.

The rotation body part may include a straight section so that the rotation body is moved in a straight line.

The upper extremity rehabilitation device may further include a second support part configured to support a hand back of the user.

The upper extremity rehabilitation device may further include a third support part located between a thumb and an index finger of the user to prevent a hand of the user from being moved by motion of the first support part.

The upper extremity rehabilitation device may further include a stimulating part configured in the first support part to provide artificial stimulation to a hand of the user.

The details of other embodiments are contained in the detailed description and accompanying drawings.

In the upper extremity rehabilitation device, a first support part rotated by a first rotation part sequentially may move fingers having different lengths to reduce energy consumption of a first rotation part as compared with a case of simultaneously moving all fingers. According to the upper extremity rehabilitation device, since respective fingers are unfolded according to a rotation angle of the first support part, there is no need to differentially set various finger forms of the user having different finger lengths every person.

In the upper extremity rehabilitation device disclosed in the specification, a second support part may support a hand back of the user to prevent a hand of the user from being bent in a direction of a hand back by the first support part. The second support part may press a hand of the user by the first support part to reduce edema of a finger by moving blood in a rotation direction of the first support. In the upper extremity rehabilitation device disclosed in the specification, the third support part is fixed by hanging a thumb of the user to prevent a hand of the user from being moved in a rotation direction of the first support part.

In the upper extremity rehabilitation device disclosed in the specification, the stimulating part provides artificial stimulation to the hand of the user to activate a neuron distributed in an inconvenient hand of the user.

The above contents provide only a selective concept with respect to more detailed contents in the simple form later. The specification has no intention to limit main characteristics or essential characteristics of claims or the scope of claims.

### BRIEF DESCRIPTION OF THE DRAWINGS

FIG. 1 is a view illustrating an upper extremity rehabilitation device according to an embodiment of the present invention;

FIG. 2 is a view illustrating an upper extremity rehabilitation device according to another embodiment of the present invention;

FIG. 3 is a perspective view illustrating an operation relationship of a rotation part shown in FIG. 2;

FIG. 4 is a view illustrating an upper extremity rehabilitation device according to another embodiment of the present invention; and

FIG. 5 is a view illustrating an upper extremity rehabilitation device according to another embodiment of the present invention.

### DETAILED DESCRIPTION OF EMBODIMENTS

For the purpose of clearly describing an exemplary embodiment of the present invention, parts which are not related to the description are omitted. The same reference numbers are used throughout the specification to refer to the same or like parts. Although embodiments have been described with reference to a number of illustrative embodiments thereof, it should be understood that numerous other modifications and embodiments can be devised by those skilled in the art that will fall within the spirit and scope of the principles of this disclosure. Those skilled in the art may variously arrange, configure, combine, and design constituent elements of this disclosure, that is, constituent elements which are described and illustrated in drawings as other constituent elements. It will be understood that all of the constituent elements are clearly devised to form a part of this disclosure. In drawings, a width, a length, a thickness, or a shape of a constituent element may be exaggerated for the purpose of clarity for a plurality of layers (films), regions, and shapes.

When a component is referred to as being “arranged at” another component, the component may be directly arranged at another component or an intervening component may be present therebetween.

When a component is referred to as being “connected to” another component, the component may be directly connected to another component or an intervening component may be present therebetween.

When a component is referred to as being “formed at” another component, the component may be directly formed at another component or an intervening component may be present therebetween.

When a component is referred to as being “linked to” another component, the component may be directly linked to another component or an intervening component may be present therebetween.

Various example embodiments will be described more fully hereinafter with reference to the accompanying drawings, in which some example embodiments are shown. The present inventive concept may, however, be embodied in many different forms and should not be construed as limited to the example embodiments set forth herein. Therefore, a range of the present invention must be determined by claims and equivalents not embodiments.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

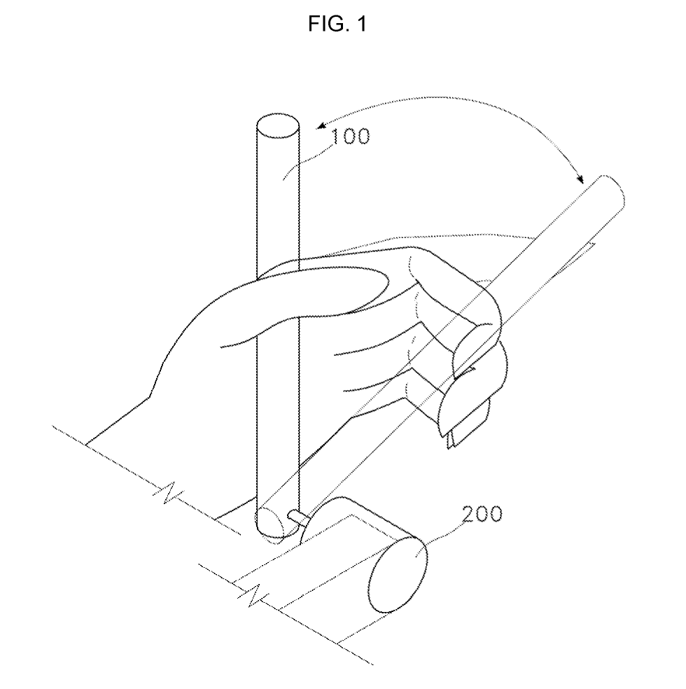

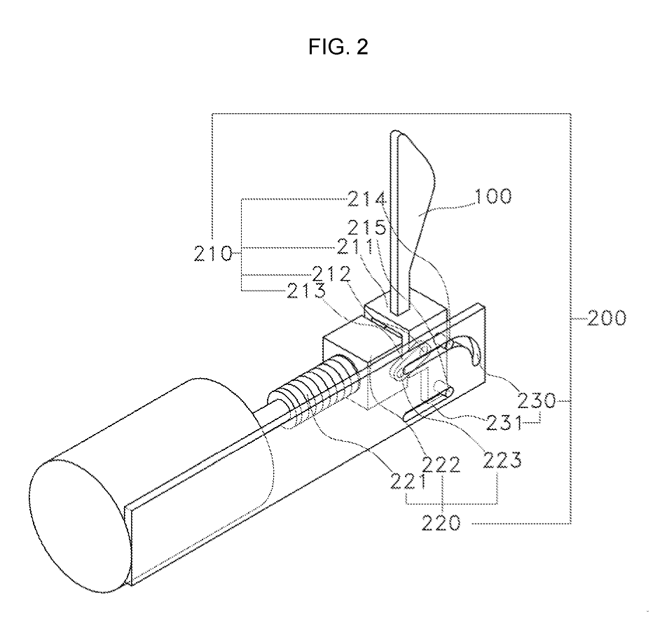

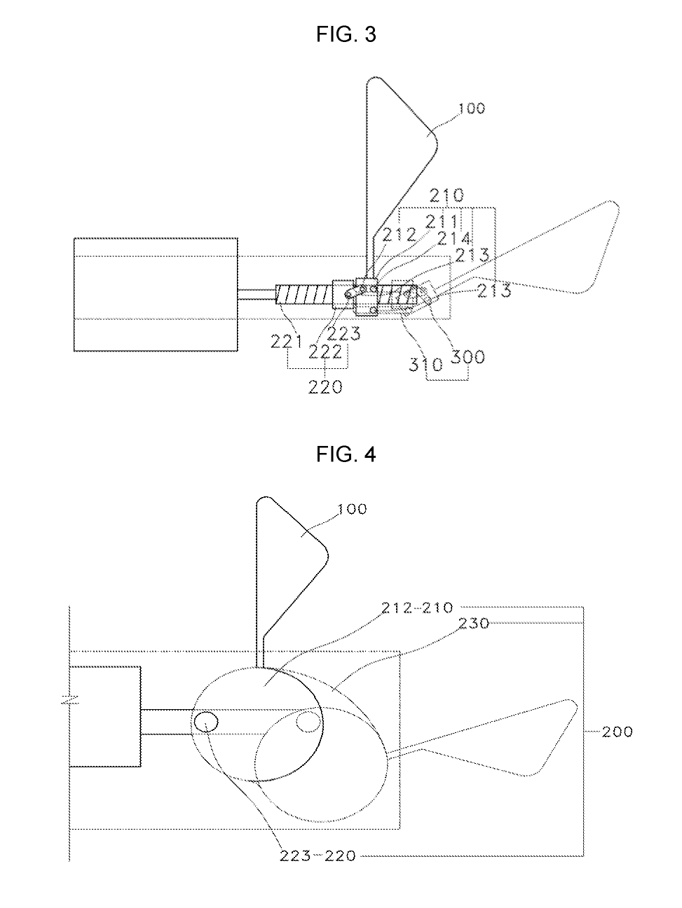

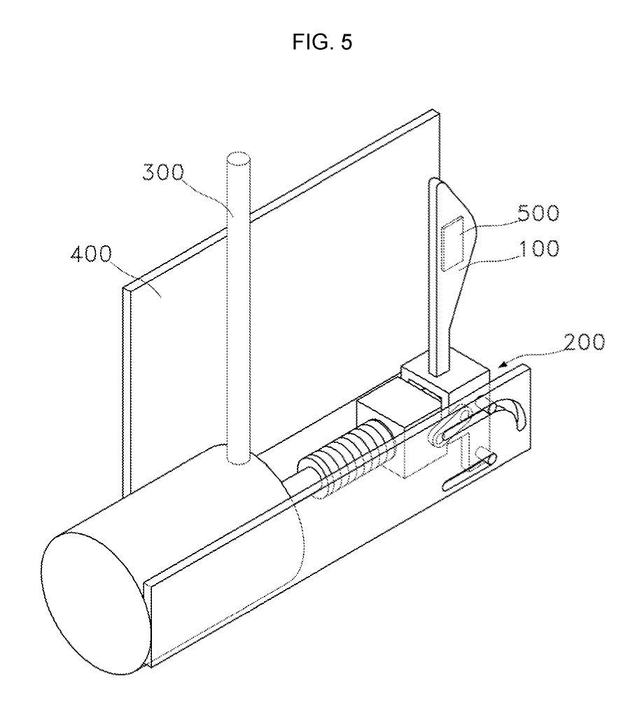

FIG. 1 is a view illustrating an upper extremity rehabilitation device according to an embodiment of the present invention, FIG. 2 is a view illustrating an upper extremity rehabilitation device according to another embodiment of the present invention, FIG. 3 is a perspective view illustrating an operation relationship of a rotation part shown in FIG. 2, FIG. 4 is a view illustrating an upper extremity rehabilitation device according to another embodiment of the present invention, and FIG. 5 is a view illustrating an upper extremity rehabilitation device according to another embodiment of the present invention.

The upper extremity rehabilitation device disclosed in the specification is a device for rehabilitating hands among an upper extremity of a human body for the purpose of a paralyzed patient who maintains a shrunk state or a patient having an inconvenient hand.

Hereinafter, the upper extremity rehabilitation device disclosed in the specification will be simply described.

The upper extremity rehabilitation device includes a first support part 100 located at a palm of a user, and a first rotation part 200 configured to rotate the first support part 100 so that one side of the first support part 100 moves from at least one finger of a user to another finger. The first support part 100 is rotated by the first rotation part 20 to sequentially push and unfold fingers of the user in a hand back direction of the user.

Referring to FIG. 1 shown in an embodiment, one side of the first support part 100 located around a thumb of a user sequentially passes through an index finger, a middle finger, a ring finger, and a baby finger based on the first rotation part as a rotation axis by operating the first rotation part 200. In this case, the first support part 100 moves and unfolds shrunk fingers in a rotating direction of the first support part 100, respectively. Fingers passed through the first support part 100 are again shrunk. When the first support part 100 is reversely rotated by the first rotation part 200, shrunk fingers of the user may be unfolded in a reverse order.

As described above, the upper extremity rehabilitation device may reduce energy consumption of the first rotation part 200 as compare with a case of simultaneously moving all fingers by sequentially moving fingers having different lengths. Since the upper extremity rehabilitation device may unfold respective fingers according to a rotation angle of the first support part 100, there is no need to differentially meet fingers having different lengths of each user with various forms of a finger of the user.

The first support part 100 and the rotation part 200 will be described in detail later.

The upper extremity rehabilitation device may further include a second support part 400 configured to support a hand back of a user.

Referring to FIG. 5 illustrating an embodiment, the second support part 400 supports the hand back of the user not to bend a hand of the user in a hand back of the user. Further, the second support part 400 presses the hand of the user by the first support part 100 to move blood in a moving path of the first support part 100. That is, the first support part 100 and the second support part 400 squeeze the hand of the user.

As described above, the second support part 400 prevents the hand of the user from being bent in a hand back by the first support part 100. The second support part may reduce edema of a finger by moving blood in a rotation direction of the first support part 100.

The second support part 400 will be described in detail later.

The upper extremity rehabilitation device may further include a third support part 300 not to move a hand of the user by the first support part 100.

Referring to FIG. 5 illustrating an embodiment, the third support part 300 gets caught at a thumb of the user.

The above third support part 300 prevents the hand of the user from being moved in a rotation direction of the firs support part100.

The third support part 300 will be described in detail later.

The upper extremity rehabilitation device may further include a stimulating part 500 installed at the first support part 100 configured to provide artificial stimulation to the hand of the user.

Referring to FIG. 5 illustrating an embodiment, the stimulating part 500 provides stimulation to a palm of the user making contact with the first support part 100.

The stimulating part 500 provides artificial stimulation to a paralyzed hand of the user to activate a neuron.

The stimulating part 500 will be described in detail later.

Hereinafter, the first support part 100, the first rotation part 200, the third support part 300, the second support part 400, and the stimulating part 500 will be described in detail.

The first support part 100 is located at a palm of the user.

Referring to FIG. 1 illustrating an embodiment, the first support part 100 may have a bar shape.

Referring to FIG. 2 illustrating another embodiment, a center region of the first support part 100 may be wider. In detail, the first support part 100 may have a triangle shape. Corners of a triangle of the first support part 100 direct to a thumb, a middle finger, and a baby finger of the user. The first support part 100 of a triangle has an area gradually narrowed in the direction of the baby finger from the middle finger.

As another example, the first support part 100 may have a rectangle shape having a wider top end or a wider bottom end or may have a square shape.

The first support part 100 may be provided at a first rotation part 200 to be described below. The first support part 100 is rotated based on the first rotation part 200 as a rotation axis. The first support part 100 is rotated based on a surface of a palm of the user as a reference plane. When the first support part 100 is formed by a plane, although the first support part 100 is rotated, fingers of the user are supported by the first support part 100. The fingers of the user may is supported at a lateral side of the first support part 100 to maintain in an unfolded state.

The first rotation part 200 rotates the first support part 100 to move one side of the first support part 100 from at least one finger of the user to another finger.

Referring to FIG. 1 illustrating an embodiment, the first rotation part 200 may include a general motor. In the first rotation part 200, a rotating shaft of a motor is provided at one side of the first support part 100. The first rotation part 200 rotates the first support part 100 based on one side of the first support part 100 as a rotation axis.

Referring to FIG. 2 to FIG. 4 illustrating another embodiment, the first rotation part 200 includes a rotation body part 210 in which the first support part 100 is provided, a rotation moving part 220 configured to move the rotation body part 210 from a wrist of the user in a heading direction of a palm, and a body rotating part 230 configured to rotate the rotation body part 210.

For example, referring to FIG. 4, the rotation body part 210, the rotation moving part 220, and the body rotating part 230 will be described as follows.

The rotation body part 210 may include a body rotation shaft 212 which is configured in the same direction as that of the moving rotation shaft 223 to be described later. The first support part 110 may be configured in the body rotation shaft 212. The body rotation shaft 212 may include a circular plate. The body rotation shaft 212 is inserted into the body rotating part 230 to be described later and is moved and rotated along the body rotating part 230. One side of the body rotation shaft 212 may include a hole (not shown) corresponding to the moving rotation shaft 223 to be described later. The hole may be formed beyond a center of the rotation body part 210.

The above rotation body part 210 may freely rotate based on the moving rotation shaft 223 of the rotation moving part 220.

The rotation moving part 220 includes a piston advancing or backing up and the moving rotation shaft 223 protruding in a heading direction of a palm of the user formed at a lateral side of the piston. The moving rotation shaft 223 may have a circular shape. The rotation moving part 220 may be provided at the moving rotation shaft 223 in which the body rotation shaft 212 is inserted.

Meanwhile, the body rotating part 230 may be implemented in various methods including that the body rotating part 230 is provided at a body of the upper extremity rehabilitation device, may be fixed on a ground or a table (not shown), and may be fixed to an arm of the user by a string. That is, the various methods may be implemented.

The body rotating part 230 may include a hole in which the above body rotation shaft 212 is inserted. The hold may extend in the form of a curve. The body rotating part 230 may support a top end and a bottom end of the rotation body part 210. The body rotating part 230 may guide the rotation body part 210 to move with a curve.

In the first rotation part 200, the rotation body part 210 advances by the rotation moving part 220. The advanced rotation body part 210 is guided by the body rotating part 230 and is rotated based on the moving rotation shaft 223. According to rotation of the rotation body part 210, the first support part 100 is rotated corresponding to a curve of the body rotating part 230.

As another example, referring to FIG. 2 and FIG. 3, the rotation body part 210, the rotation moving part 220, and the body rotating part 230 will be described as follows.

The rotation body part 210 includes a rotation body 211 in which the first support part 100 is provided, a body rotation shaft 212 provided in the same direction as that of the moving rotation shaft 223, a body connector 213 including both sides inserted into the moving rotation shaft 223 and the body rotation shaft 212, and a body guide 214 provided in the same direction as that of the body rotation shaft 212 in the rotation body 211.

The rotation body 211 of the rotation body part 210 may include a plate. The first support part 100 is provided upward of the plate.

The body rotation shaft 212 of the rotation body part 210 includes a configuration protruding in the same direction as that of the moving rotation shaft 223 at a lateral side of the rotation body 211. Hereinafter, the moving rotation shaft 223 of the rotation moving part 220 is configured in a heading direction of a palm of the user positioned on the first support part 100. The body rotation shaft 212 is configured so that a body connector 213 to be described later freely rotates. The body rotation shaft 212 causes the body connector 213 to rotate based on the body rotation shaft 212 by using a palm of the user as a reference plane.

Holes may be formed at both ends of the body connector 213 of the rotation body part 210, respectively. Both sides of the body connector 213 freely rotate based on the body rotation shaft 212 and a moving rotation shaft 223 of the rotation moving part 220 to be described later. The body connector 213 includes two joints through the body rotation shaft 212 and the moving rotation shaft 223 when the rotation body 211 is rotated from the rotation moving part 220 to be described later.

The body guide 214 of the rotation body part 210 protrudes in the same direction as that of the body rotation shaft 212 in the rotation body 211. The body guide 214 is inserted into the body rotating part 230 to be described later.

The above rotation body part 210 moves along a body connector 213 connected with the rotation moving part 220 to be described later. The body guide 214 of the rotation body part 210 is guided and moved in a body rotating part 230 to be described later, and the body guide 214 rotates along a curve of the body rotating part 230. When the body rotating part 230 rotates, the rotation body 211 is rotated to rotate the first support part 100.

The rotation moving part 220 includes a moving bar 221 formed therein with a thread to be rotated, a moving body 222 being bi-directionally moved in a rotation direction of a moving bar 221, and a moving rotation shaft 223 configured in a heading direction of a palm of the user in the moving bar 222.

The moving bar 221 may include a bar including a surface formed therein with a thread. The moving bar 221 may include a general motor (not shown) at a side thereof to be rotated in a direction of a thread. One side of the moving bar 221 directs in a wrist of the user and another side thereof may be located at a direction of a finger of the user.

Meanwhile, a direction of the moving bar 221 may be variously changed. A gear capable of be directly rotated by the user may be included instead of the motor.

The moving body 222 may include a through hole formed therein with a screw thread corresponding to the above moving bar 221. The moving body 222 may be moved in a longitudinal direction of the moving bar 221. A lateral side of the moving body 222 may be supported by the body rotating part 230. The moving body 222 is supported by the body rotating part 230 and is moved in a longitudinal direction of the moving bar 221 according to rotation of the moving bar 221.

The moving rotation shaft 223 may include a circular protrusion. The moving rotation shaft 223 may be provided at a lateral side of the moving body 222. The moving rotation shaft 223 may protrude in a heading direction of a palm of the user which is positioned on the first support part 100.

The rotation moving part 220 may finely move the moving body 222 by adjusting rotating speed of the moving bar 221 and a slope angle of a screw thread. The rotation moving part 220 moves the body connector 213.

Meanwhile, a general piston may be configured instead of the moving bar 221 and the moving body 222.

The body rotating part 230 may include a hole in which the body guide 214 is inserted. The hole may extend with a curve shape. The body rotating part 230 supports a top portion and a bottom end of the body guide 214.

The body rotating part 230 guides the rotation body part 210 to move with a curve.

The rotation body part 210 of the first rotation part 200 advances by the rotation moving part 220. The advanced rotation body part 210 is guided by the body rotating part 230 to be rotated based on a moving rotation shaft 223. According to rotation of the rotation body part 210, the first support part 100 is rotated corresponding to a curve of the body rotating part 230.

Meanwhile, the present example further includes a body fixing guide 215 configured in the same direction as that of the body guide 214 in the rotation body part 210. The body rotating part 230 may further include a body fixing hole 231 in which the body fixing guide 215 is inserted.

The body fixing guide 215 may have a cylindrical shape. The body fixing guide 215 is provided at a position different from the body guide 214 at a lateral side of the rotation body part 210. The body fixing guide 215 is inserted into the body fixing hole 231 to be described later.

The body fixing hole 231 includes a hole having a size capable of inserting a body fixing guide 214 as described above. The body fixing hole 231 supports a rotation body 211 rotated by the body rotating part 230 to prevent indiscreet rotation based on the body rotation shaft 212.

The first rotation part 200 including the body fixing guide 215 and the body fixing hole 231 is rotated based on the body fixing guide 215 or the body fixing hole 231 by rotation of the first support part 100. That is, the body fixing guide 215 or the body fixing hole 231 becomes a center of rotation of the rotation body 211, and the body guide 214 guides a rotation path of the rotation body 211.

In addition, the rotation body part 210 may include a straight section as shown in FIG. 2 or FIG. 3. Moreover, the body fixing hole 231 may have the same length as that of the straight section. The straight section is a section where a rotation body 211 of the rotation body part 210 may be horizontally moved along the rotation moving part 220. The straight section may be moved in a rotation range of the first support part 100 toward a finger of the user. That is, when a length of a hand of the user is greater than a length of the first support part 100, a problem which cannot unfold the tip of a finger of the user.

The second support part 400 support a hand back of the user.

Referring to FIG. 5 illustrating an embodiment, the second support part 400 may be flat to support the hand back of the user. The second support 400 may face a lateral side of the first support part 100. The second support part 400 may be spaced apart from the first support part 100 by a predetermined distance. The hand of the user is inserted between the second support part 400 and the first support part 100. The second support part 400 prevents the hand of the user from being bent in a direction of the hand back by supporting the band back of the user. In addition, the upper extremity rehabilitation device including the second support part 400 may press the hand of the user to the first support 100 to move blood to a moving path of the first support part 100. That is, the first support part 100 and the second support part 400 squeeze the hand of the user.

As described above, the second support part 400 prevents the hand of the user from being bent in a hand back by the first support part 100. In detail, the hand of the user is prevented from being bent in the direction of the hand back by force of the first support part pushing a finger of the user. Further, the upper extremity rehabilitation device may move blood in a rotation direction of the first support part 100 to reduce an edema of the finger.

Meanwhile, the second support part 400 may be configured in a body (not shown) of the upper extremity rehabilitation device, may be fixed to a ground or a table, may be fixed to an arm of the user (not shown) through a string, and may be separately fixed to the first rotation part 200. That is, the second support part 400 may be formed by the above various methods.

The second support part 400 may include an elastic material.

The third support part 300 prevents the hand of the user from be moved by the first support part 100.

Referring to FIG. 5 illustrating an embodiment, the third support part 300 may include a circular bar. The third support part 300 may be located between a thumb and a palm of the user. The third support part 300 gets caught at the thumb of the user.

The third support part 300 prevents the hand of the user from being moved in a rotation direction of the first support part 100.

Meanwhile, the third support part 300 may be configured in a body (not shown) of the upper extremity rehabilitation device, may be fixed to a ground or a table, may be fixed to an arm of the user (not shown) through a string, and may be separately fixed to the first rotation part 200. That is, the second support part 400 may be formed by the above various methods. The third support part 300 will be described in detail later.

The stimulating part 500 provides artificial stimulation to the hand of the user.

Referring to FIG. 5 illustrating an embodiment, the stimulating part 500 may include a general vibration device. The stimulating part 500 may be configured inside the first support part 100. The stimulating part 500 provides vibration stimulation to a palm of the user making contact with the first support part 100.

Meanwhile, in order to supply power for operating the stimulating part 500, a power line may be connected by the first support part 100, and may be as a structure capable of installing and separating a vibration device including a battery. The stimulating part 500 may include a general electroshock weapon or a general ultrasound device. The stimulating part 500 may be attached to an outside of the first support part 100.

The stimulating part 500 may provide artificial stimulation to a paralyzed hand of the user in various schemes such as vibration or electricity to activate a neuron.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An upper extremity rehabilitation device comprising:
a first support part located at a palm of a user; and
a first rotation part configured to rotate the first support part so that one side of the first support part moves from at least one finger of a user to another finger to unfold fingers having different lengths.

2. The upper extremity rehabilitation device of claim 1, wherein the first support part comprises a wider middle part.

3. The upper extremity rehabilitation device of claim 1, wherein the first rotation part comprises:
a rotation body part in which the first support part is provided;
a rotation moving part configured to advance and retreat the rotation body part from a wrist of the user in a heading direction of a palm; and
a body rotating part configured to rotate the rotation body part.

4. The upper extremity rehabilitation device of claim 3, wherein the rotation moving part comprises:
a moving bar formed therein with a thread to be rotated;
a moving body being bi-directionally moved in a rotation direction of a moving bar; and
a moving rotation shaft configured in a heading direction of a palm of the user in the moving bar,
wherein the rotation body part comprises:
a rotation body in which the first support part is configured;
a body rotation shaft configured in the same direction as that of the moving rotation shaft in the rotation body;
a body connector including both sides inserted into the moving rotation shaft and the body rotation shaft; and
a body guide provided in the same direction as that of the body rotation shaft in the rotation body,
wherein the body guide is inserted into the body rotating part so that the body rotating part is moved with a curve based on the moving rotation shaft or the body rotation shaft.

5. The upper extremity rehabilitation device of claim 4, wherein the rotation body part further comprises a body fixing guide configured in the same direction as that of the body guide, and
the body rotating part comprises a body fixing hole in which the body fixing guide is inserted.

6. The upper extremity rehabilitation device of claim 4, wherein the rotation body part comprises a straight section so that the rotation body is moved in a straight line.

7. The upper extremity rehabilitation device of claim 1, further comprising a second support part configured to support a hand back of the user.

8. The upper extremity rehabilitation device of claim 2, further comprising a second support part configured to support a hand back of the user.

9. The upper extremity rehabilitation device of claim 3, further comprising a second support part configured to support a hand back of the user.

10. The upper extremity rehabilitation device of claim 4, further comprising a second support part configured to support a hand back of the user.

11. The upper extremity rehabilitation device of claim 5, further comprising a second support part configured to support a hand back of the user.

12. The upper extremity rehabilitation device of claim 6, further comprising a second support part configured to support a hand back of the user.

13. The upper extremity rehabilitation device of claim 1, further comprising a third support part located between a thumb and an index finger of the user to prevent a hand of the user from being moved by motion of the first support part.

14. The upper extremity rehabilitation device of claim 1, further comprising a stimulating part configured in the first support part to provide artificial stimulation to a hand of the user.

15. The upper extremity rehabilitation device of claim 2, further comprising a stimulating part configured in the first support part to provide artificial stimulation to a hand of the user.

16. The upper extremity rehabilitation device of claim 3, further comprising a stimulating part configured in the first support part to provide artificial stimulation to a hand of the user.

17. The upper extremity rehabilitation device of claim 4, further comprising a stimulating part configured in the first support part to provide artificial stimulation to a hand of the user.

18. The upper extremity rehabilitation device of claim 5, further comprising a stimulating part configured in the first support part to provide artificial stimulation to a hand of the user.

19. The upper extremity rehabilitation device of claim 6, further comprising a stimulating part configured in the first support part to provide artificial stimulation to a hand of the user.
